(19) United States
(12) Patent Application Publication
(10) Pub. No.: US 2007/0282639 A1
(43) Pub. Date: Dec. 6, 2007

(54) Method and System for Enabling Automatic Insurance Claim Processing

(76) Inventors: Mary E. Leszuk, Unionville, CT (US); Linda S. Desjardins, Marlborough, CT (US); David M. Henne, Richfield, MN (US); Eileen Doyle, Vernon, CT (US); Tracine A. Companion, Middle Grove, NY (US)

Correspondence Address: DORSEY & WHITNEY LLP;INTELLECTUAL PROPERTY DEPARTMENT, SUITE 1500, 50 SOUTH SIXTH STREET, MINNEAPOLIS, MN, 55402-1498, US

(21) Appl. No.: 11/562,131

(22) Filed: Nov. 21, 2006

Related U.S. Application Data
(60) Provisional application No. 60/738,433, filed on Nov. 21, 2005.
(60) Provisional application No. 60/748,620, filed on Dec. 8, 2005.

(51) Int. Cl. G06Q 40/00; G06F 3/01

(52) U.S. Cl. 705/4; 715/700

(57) ABSTRACT

An administrative support system and method for automatically processing insurance claims is provided. The system includes data storage and a processor, where the system retrieves data associated with an insurance claim, identifies at least one issue associated with the retrieved insurance claim data, analyzes the insurance claim data and the at least one issue using at least one predefined condition to determine whether issues can be resolved automatically, and automatically resolves the analyzed insurance claim data having the associated at least one issue meeting the at least one predefined condition. The method includes retrieving data associated with an insurance claim, identifying at least one issue associated with the retrieved insurance claim data, analyzing the insurance claim data and the at least one issue using at least one predefined condition to determine whether issues can be resolved automatically, and automatically resolving the analyzed insurance claim data having the associated one or more issues meeting the at least one predefined condition.

### CROSS-REFERENCE TO RELATED APPLICATION(S)

The present invention claims benefit under 35 U.S.C. § 119(e) to U.S. Provisional Patent Application No. 60/738,433, filed on Nov. 21, 2005; and also claims benefit to U.S. Provisional Patent Application No. 60/748,620, filed Dec. 8, 2005, both of which are herein incorporated by reference in their entireties.

### FIELD OF THE INVENTION

The present invention relates to facilitating insurance claim adjustments, by providing a method and system for determining whether issues related to an insurance claim can be resolved automatically and sending the automatically resolvable claims for automatic processing.

### BACKGROUND OF THE INVENTION

Claims adjustment processes typically are manual processes. As the number of individuals taking advantage of the opportunity to defray the costs of health care and other liabilities by purchasing insurance increases, the number of insurance claim adjustments grows each year, and an overload of adjustment requests are received for procession. In addition, manual adjustment processes are difficult to monitor, trend, and manage, and may result in a loss of productivity.

### SUMMARY OF THE INVENTION

In view of the drawbacks described above, the present invention provides a system and method for reviewing previously finalized claims needing adjustment to determine whether claims may be automatically adjusted or manually adjusted via an electronic work queue. The system and method may analyze one or more of the claim data, member data, claim history, identified issues, categorization, and/or claim destination, and as a result of analyzing, determine whether the claim data may be automatically adjusted or requires manual adjustment via an electronic work queue. Where the claim may be automatically adjusted, the claim is routed to an automatic adjustment processor, and where the claim requires manual adjustment, the claim is sent to an electronic work queue. In one implementation, where a claim has been paid to the wrong payee or provider, the claim has been paid for the incorrect member or provider, there is a claim underpayment or overpayment, or if a contract exception is identified, the analysis of the claim data by the system may result in a determination that the claim is in a condition for automatic adjudication. In another example, the system may determine automatically that the claim data is to be sent to an automatic readjudication system for resolution when the system indicates that the claim was previously submitted with incomplete, missing, or incorrect information.

In one such system and method, a computer application is provided for analyzing claims to identify claim issues, e.g., reasons the claim needs readjudication, and to determine whether the claim issues may be automatically resolved or sent to an electronic work queue for manual adjudication by a claims processor.

Another system and method involves providing a computer application for analyzing claim issues to determine whether the claim issues may be automatically resolved, and automatically reprocessing the claim in order to reach a point of resolution. In a further example, a grouping of claims that may be automatically resolved may be grouped and sent for reprocessing together. This may be useful, for example, where the same claim issue is present for a group of claims. In yet a further example, where the claim or claims qualify for automatic reprocessing, but fail the automatic reprocessing process, the method further involves sending the claims for manual adjustment.

In yet another system and method, a computer application analyzes claim issues and routes the claim issues to an appropriate electronic work queue for review and manual adjustment by a claims adjuster.

The claims analyzed using the system and method of the present invention may be previously adjudicated claim transactions. For example, the previously adjudicated claims may be retrieved upon a provider or member claim inquiry, or as a result of a system change affecting a grouping of previously adjudicated claims. For example, a previously adjudicated claim transaction that has been paid under the wrong contract may be retrieved by a CCP upon a member or provider inquiry, and the CCP may identify the appropriate claim issue code corresponding to the reason the claim requires readjustment. Upon issue identification, the system may analyze the claim transaction data to determine whether the claim may be automatically resolved using automatic processing, and if the claim data meets certain conditions for automatic resolution, the claim data may be sent to an automatic processing program or other work queue. In one example, the claim data may be prepared for automatic resolution and maintained in a database until it is retrieved by an automatic claims resolution program. In further implementations of the invention, an automatic claims processing/reprocessing system receives the prepared claim data and automatically processes the claim to resolve the issue.

A method for providing automated insurance claim processing includes retrieving data associated with an insurance claim, identifying at least one issue associated with the retrieved insurance claim data, analyzing the insurance claim data and the at least one issue using at least one predefined condition to determine whether the at least one issue can be resolved automatically, and automatically resolving the analyzed insurance claim data having the associated at least one issue meeting the at least one predefined condition when the insurance claim data can be resolved automatically.

A system for enabling automatic insurance claim processing includes data storage for storing claims data to be processed, and a processor for retrieving data associated with an insurance claim, identifying at least one issue associated with the retrieved insurance claim data, analyzing the insurance claim data and the at least one issue using at least one predefined condition to determine whether the at least one issue can be resolved automatically, and automatically resolving the analyzed insurance claim data having the associated at least one issue meeting the at least one predefined condition when the insurance claim data can be resolved automatically, else, routing the analyzed insurance claim data having the associated at least one issue meeting the at least one predefined condition to an electronic work queue when the insurance claim data can not be resolved automatically.

A computer-implemented software application, according to certain implementations, enables a user to retrieve data associated with an insurance claim, identify at least one issue associated with the retrieved insurance claim data, analyze the insurance claim data and the at least one issue using at least one predefined condition to determine whether the at least one issue can be resolved automatically, and route the analyzed insurance claim data for automatic resolution or for manual adjustment.

In further implementations, the system includes an automatic claims adjudication system for processing and reprocessing claims. The system receives the claim data that qualifies for automatic reprocessing and analyzes the data to determine whether reprocessing the claim would resolve an overpayment or underpayment or whether reprocessing the claim would result in no change. In some instances, the automatic processing may determine that the data cannot actually be reprocessed and directs the claim data to manual work queues.

The methods and systems for determining whether an issue related to an insurance claim may be automatically resolved and resolving the claim issue may apply for various types of insurance including medical, life, liability, or property insurance.

These and other features and advantages of the present invention will become apparent to those skilled in the art from the following detailed description, wherein it is shown and described illustrative embodiments of the invention, including best modes contemplated for carrying out the invention. As it will be realized, the invention is capable of modifications in various obvious aspects, all without departing from the spirit and scope of the present invention. Accordingly, the drawings and detailed description are to be regarded as illustrative in nature and not restrictive.

### BRIEF DESCRIPTION OF THE DRAWINGS

FIG. 1 is a diagram of an exemplary system for providing automated claims processing.

FIG. 2 depicts a method for automatically reprocessing insurance claim data that may be automatically processed.

FIG. 3 depicts one embodiment of a method for analyzing claim data to determine whether a claim issue may be automatically resolved.

FIG. 4 depicts an example screen shot of a desktop application for facilitating automatic resolution of claim issues.

FIG. 5 is an illustration of a substitution table for facilitating substitution of claim data.

### DETAILED DESCRIPTION OF THE INVENTION

A system and method for automatically processing claims may include a computer-implemented application for retrieving and analyzing claim data to determine whether one or more claims may be sent to an automated transaction generator where the claim may be further analyzed to determine whether the claim may be automatically adjudicated or be routed to an electronic work queue that presents claim data in an adjustment format for manual adjustment. Processing claims may involve determining whether claim changes were made from the time the claim was originally processed to the time of request for readjudication, or to the time of processing the request for readjudication. In addition, claims may be processed, according to certain implementations, by identifying one or more claim issues or reasons the previously finalized claim requires readjudication, and further processing the claim according to the type of readjudication required.

The system, according to certain configurations, is arranged at a front end as an administrative support application to provide a customer care professional (CCP) with a user interface that enables the CCP to document claim inquiries, such as claim adjustment inquiries. The system integrates the documented claim information from a variety of database sources, and determines whether the claim information meets conditions that qualify it to be processed in an automated transaction generator. Claim data meeting the requisite conditions is sent to an automated transaction generator where the claim data may be automatically adjudicated, e.g., may be automatically adjusted, or where the claim data may be routed for manual adjustment. Claims requiring manual adjustment may be presented to a back end of the system in an electronic work queue in an adjustment format for manual adjustment by a claims adjuster.

In some implementations, the system may facilitate conversion of the data associated with the insurance claim into a suitable form by reviewing and/or processing claim data and/or documentation submitted by a CCP. For example, the system may correct claim data that is incorrect, missing, or incomplete.

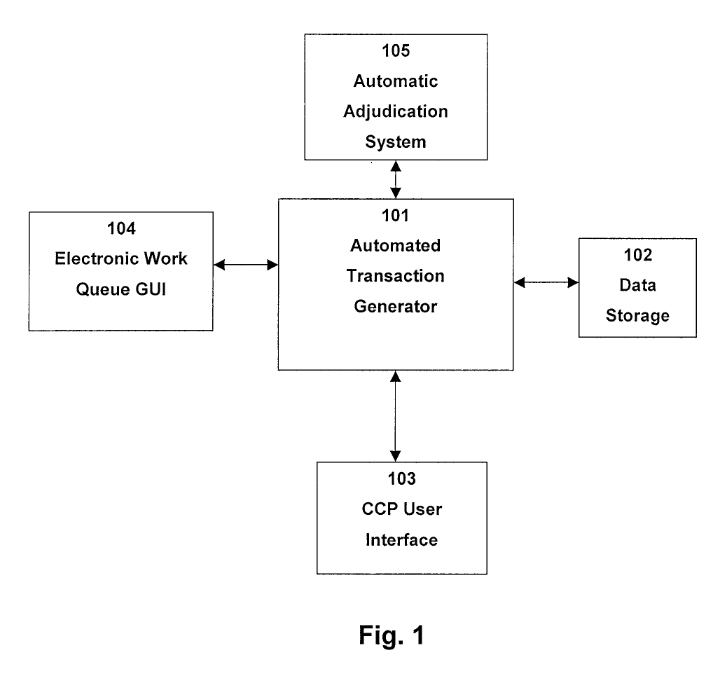

FIG. 1 provides a diagram of a system for providing an automated claims processing method to enable the system and/or users to seamlessly process previously adjudicated claims. The system includes an automated transaction generator 101 that communicates (via secure communication methods) with data storage component 102, one more a CCP user interface 103, an electronic work queue 104, and an automatic adjudication system 105. Notably, the system may be implemented in a hub configuration with the processor located at a central location, or may be implemented as a distributed network of components. In addition, one or more of the system components may be integrated into the automated transaction generator. For example, the automated transaction generator may operate as an automatic adjudication system.

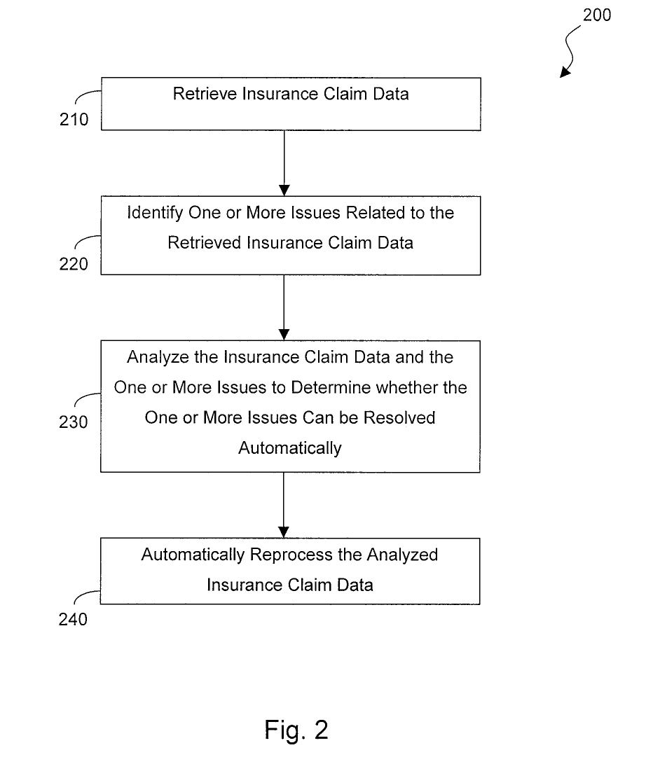

FIG. 2 depicts an exemplary method 200 for automatically processing an insurance claim. According to method 200, data associated with an insurance claim is retrieved 210. Retrieval of insurance data may be precipitated by a phone or online inquiry from a customer, provider, or other party authorized to conduct business related to the claim, may be retrieved based on a claims system change that requires readjudication of a grouping of previously adjudicated claims, or may be retrieved based on an uploaded file. Accordingly, data retrieval requests may be via an administrative support system, or via other software or electronic systems. The claim data retrieved may be an entire record associated with the insurance claim, a partial record associated with the insurance claim, or an entire claim history.

One or more issues related to the retrieved insurance claim data are identified 220, and one or both of the retrieved insurance claim data and the identified issues are analyzed 230 to determine whether the issue can be submitted to an automated transaction generator where the issue may be further analyzed to determine whether the issue may be resolved automatically or sent to an electronic work queue for manual resolution. Insurance claim data having one or more issues that can be automatically resolved may be automatically processed 240 in an automatic claim processing area, such as an automatic claim adjustment system.

In one exemplary implementation, a CCP receives an inquiry such as an incoming call from a provider or member regarding a member's previously adjudicated claim. The CCP searches for and verifies the member's identity, and prompts the system to retrieve information related to the member's claims. The system displays the retrieved information on a graphical user interface (GUI) or in printed or electronic format for the CCP to review. For example, claims data may be displayed based on the date of service associated with the claim or in any other desired configuration.

According to this implementations, the CCP may select the claim of interest via the GUI, and upon claim selection, the system or the CCP may identify an issue associated with the claim that needs resolving. For example, the claim may have been underpaid, in which case the CCP identifies the underpayment issue on the GUI by selecting a reason code corresponding to claim underpayment. Alternatively, the system may analyze the claim data to identify one or more issues and automatically assign a reason code to the claim.

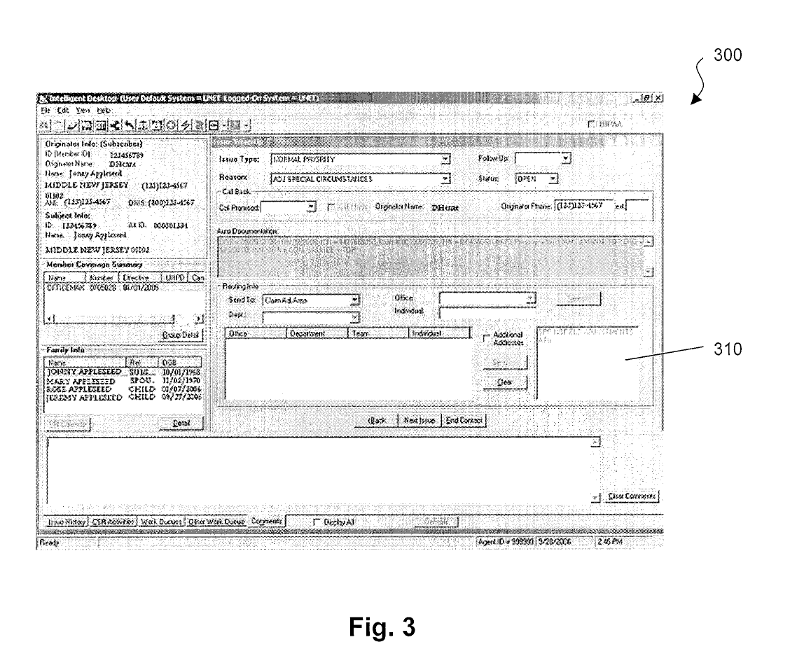

For example, FIG. 3 depicts an example screen shot 300 of a desktop application a CCP may access where the reason code “adjustment special circumstances” 310 is displayed. This type of reason code for the claim inquiry may be the result of original claim data having missing, incomplete, or incorrect information. In certain instances, the system may automatically assign a reason code when it retrieves claim data as a result of a CCP claim inquiry. However, according to some configurations, a CCP may override the system's default selection of the reason code and assign a new reason code from a list box. Other examples of reason codes the system and/or CCP may assign to a claim include that the claim was paid and processed or that the claim requires adjustment. Depending on the reason code, for example, the claim may be further analyzed to determine whether the claim with its associated claim issue may be submitted to an automated transaction generator for either automatic readjudication or manual processing.

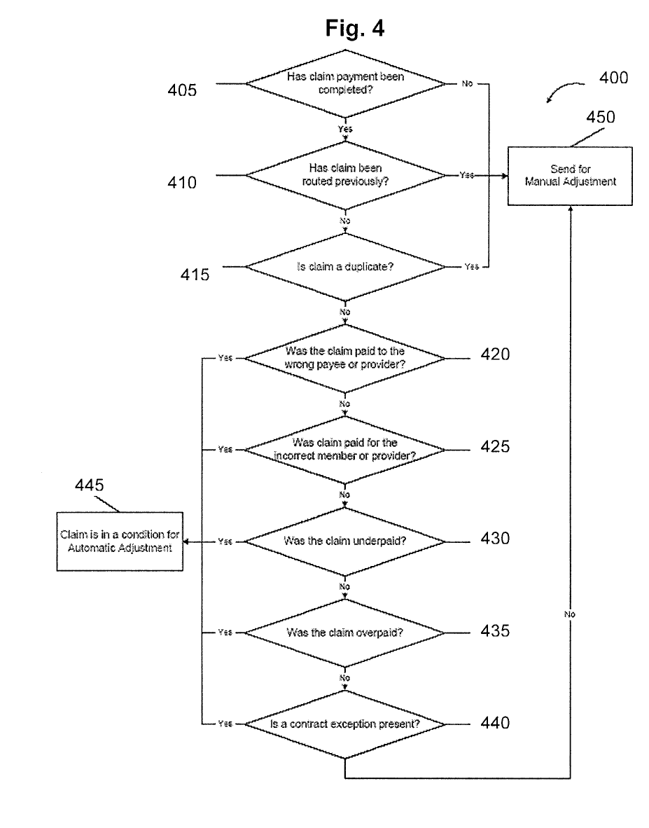

FIG. 4 depicts an exemplary method 400 for analyzing claim data to determine whether a claim issue may be submitted to an automated transaction generator for automatic resolution or manual resolution via an electronic work queue. According to method 400, claim data is required to meet one or more predefined claim conditions to be suitable for submission to an automated transaction generator. Predefined claim conditions may include a requirement that the claim payment be complete 405, that the claim not have been previously routed 410, and/or that the claim not be a duplicate 415. If one or more predefined conditions are not met, the claim may be sent for manual adjustment 450. If each applicable condition, e.g., 405, 410 and 415 is met, then the claim may data may be further processed to determine whether the issue associated with the claim is suitable for processing by the automated transaction generator.

In method 400, if the claim issue is that the claim has been paid to the wrong payee or provider 420, has been paid for the incorrect member or provider 425, is an underpayment 430, is an overpayment 435, and/or if a contract issue is identified 440, then the claim is in a condition for submission automatic adjustment 445, and the claim may be forwarded to an automatic claims processing system. This may be determined by examining a reason code on a GUI that corresponds to an identified claim issue. Those skilled in the art will understand that any set of one or more predefined conditions, in addition to or as an alternative to the conditions of 420, 425, 430, 435, or 440, may be used in method 400 to sort claim data into data that may be adjusted automatically and data that requires manual adjustment. For example, if the claim issue is that the procedure related to the claim was incorrectly coded, the claim may be sent for manual adjustment 450. In another example, if the claim issue is that the incorrect provider contract was loaded, that the provider contract has been fixed, or that the claim is part of a group settlement, then the claim may be sent to an automated transaction generator where the claim may be automatically adjusted or presented to a manual adjuster in an electronic queue in an adjustment format.

Claims suitable for processing by an automated transaction generator may be routed to the automated transaction generator where the claim data may be analyzed further to determine whether the claim data may be submitted for automatic resolution, e.g., automatic adjustment, or for manual adjustment via an electronic work queue.

When a the automated transaction generator, for example, determines the claim may be automatically adjusted the claim data, and in some instances, the associated record, described further below, may be sent to an automatic adjustment system for automated adjustment and reprocessing. In certain configurations, the automated adjustment system reviews claim data and associated substitution data and determines or verifies whether there was a claim overpayment, underpayment, or no change in the claim allowable or payable. For claims data having an underpayment, additional processing may allow for the issuance of additional money to cover the deficiency. For claims having an overpayment, additional processing may enable the system to post overpayments. For claims having no change, additional processing may enable the system to determine whether a member should be provided with an explanation of their insurance benefits, for example. In certain implementations, claim data suitable for automatic processing and may be tested determine what the outcome of reprocessing the claim data would be. If the reprocessing would result in resolution of the issue, the system completes the transaction. In other implementations, if the claim that qualifies for automated adjustment fails to automatically adjust, the system may route the claim data to one or more work queues for manual adjustment. For example, the system may route the claim data to an electronic work queue for to be worked on by an adjuster. The claim data may be routed to a specific electronic work queue, for example, based on the reason the claim failed to automatically adjust.

When a the automated transaction generator determines the claim is not capable of being automatically adjusted, the automated transaction generator routes the claim to an electronic work queue for manual adjustment. Claim data may be presented to the manual adjuster in an adjustment format that allows the adjuster to make changes to the claim data. The system may present the adjuster with information on the type of editing the claim data requires in order to properly readjudicate the claim data. The manual adjuster may review the claim data and any record generated by the system or by a CCP as a result of an online or phone inquiry, for example.

According to another exemplary implementation, claim data may be analyzed by the system to determine whether the claim data may be substituted for new data. For example, the system may enable manual data substitution when allowed via a special substitution screen. If one or more of the substitution conditions is met, then items in the claim may be substituted. In instances where it is not appropriate for the claim to receive substitution data, the system may route the claim data for manual adjustment or further processing. In some implementations, claim data is not substitutable by a CCP but requires substitution once it reaches the manual adjuster, and a CCP instead may be provided with a comment field enabling the CCP to enter a message that may facilitate the manual adjuster's data substitution.

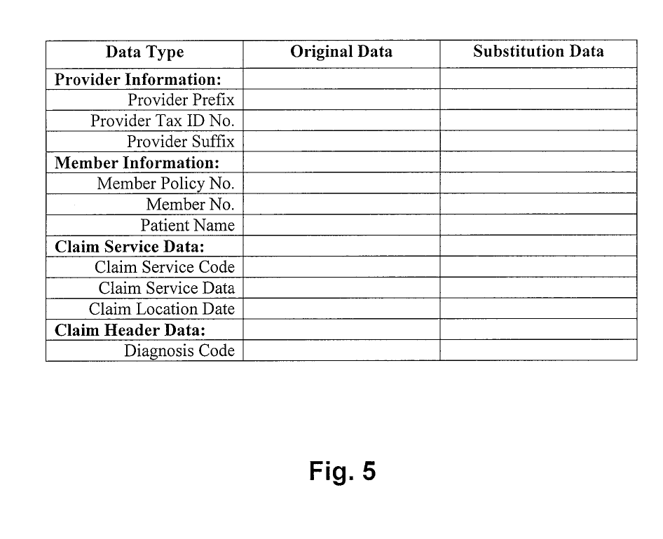

In some implementations, when substitution changes are to be made by a CCP or a manual adjuster, the system may display a substitution screen on the GUI. The substitution screen may be formatted as a table showing an original data column, and an adjacent substitution data column. The rows of the table may list a description of the data (e.g., policy number, date of service, diagnosis code), the original data (in the original data column), and a blank field (in the substitution column) for substitution data to be filled-in by the manual adjuster. FIG. 5 provides an exemplary substitution screen that may have the original data column automatically filled in by the system and in which the CCP or claim adjuster may enter substitution data. By displaying the substitution screen in a table format, the CCP or manual adjuster may view the original data while updating incorrect, missing and incomplete claims data. In addition, the table format enables the CCP or manual adjuster to verify easily the changes with the member or provider.

In some configurations, the system may notify a CCP or manual adjuster of issues identified by the system so that the manual adjuster can review and/or correct the issue. The system also may provide the CCP or manual adjuster with options for correcting the issue. For example, a pull down menu or listing of items may be displayed on the GUI for review and for selecting the appropriate data for addressing the issue. The system additionally may provide check boxes or a text box facilitating entry of substitution claim data for the original claim data.

In a further configuration, the system determines that the substitution can be performed automatically and substitutes the appropriate claim data automatically. Alternatively, the claim data and associated record, described further below, may be sent to an automatic adjudication system for automated substitution, adjustment and reprocessing.

For substitution of claim data, the types of claim data that may be substituted may include, for example, claim level data such as job number, provider data such as provider prefix, tax ID number, and suffix, member data such as policy number, member number, and relationship code, claim service level data such as service code ranges (e.g., CPT and HCPCS codes), date of service, place of service, and patient name, and claim header data such as diagnosis code.

According to further implementations, for claims that meet substitution conditions, the system further may analyze each item in the claim in order to determine the specific items in the claim data that may be substituted. For example, the system may identify items that are incomplete, incorrect, or missing, and enable only those items to have their original data substituted with new data.

In a further exemplary implementation, the system analyzes the claim in order to determine what portion(s) of the data, if completed, corrected or added, would result in the claim being capable of automatic resolution, for example, via an automatic claim transaction processing program.

The system may correct claim deficiencies to enable automatic processing and resolution, and/or may prepare claims for automatic or manual processing without correcting claim deficiencies. For example, the system may flag that a claim issue is present and submit the claim for automatic processing without adding new or corrected claim data. In such a case, the claim issue may not be resolved until after it is received and processed by an automatic claims processing program. In another example, the system may flag a claim issue and identify the possible claim edits and present the information to a manual claims adjuster via an electronic work queue.

During the claim resolution process, when a claim is identified as needing reprocessing and/or if substitution data is entered and submitted, the system may document information related to the claim such as inventory control number, date of service, provider, total charge, substituted items and reason for the substitution. Furthermore, the CCP may add other documentation related to the call. The system may append the documentation data to its related claim, and may tag the data as requiring readjudication or reconsideration. In addition or alternatively, documentation may be saved in a table, or stored as a stand alone file; and may facilitate resolution of the claim issue, for example, by providing information related to the type of issue associated with the claim and/or the type of processing the claim issue requires in order to be resolved.

Documenting some or all of the data that the CCP and/or claim adjuster is required to input into the system may reduce the amount of time the CCP and/or claim adjuster spends creating records and the chance of data errors. When the system identifies an issue with the claim, the system automatically may document the issue and any action taken by the system, CCP and/or claim adjuster to resolve it.

In some implementations, additional data records may be generated from the claim data and/or an appended record. For example, an additional data record may be generated specifically for the type of adjudication to be performed. For an automatic adjudication system, an additional data record identifying a claim inventory control number, check draft number, and original and substitution data may be generated and stored as a stand alone file, appended to the data associated with a previously adjudicated claim, stored in an index or table, and/or stored in an “issue history” portion of the record for the claim data. For manual adjustment via an electronic work queue, a data record may be formatted so that the record is displayed in appropriate fields on a manual adjuster's adjustment work screen.

In some configurations, the claim and its processing or reprocessing status may be reviewed by a CCP by recalling the claim and, for example, viewing the history associated with the claim and/or issue to be resolved. For example, the claim may be revisited by a CCP to view the activity and/or status of the claim readjudication. Thus, according to some implementations, the a claim record may be updated to track the progress of the reprocessing of the claim.

According to certain configurations, claims adjudication systems, such as those described in U.S. Pat. No. 5,359,509, having an issue date of Oct. 25, 1994, and entitled “Health Care Payment Adjudication and Review System”, which is incorporated herein by reference in its entirety, may be implemented along with the disclosed inventive methods and systems.

An optional administrative support system includes one or more CCP workstations coupled to a host system via, for example, a network. The host system may be configured to communicate with various databases and software and may operate in the manner disclosed in U.S. Pat. No. 6,112,183, having an issue date of Aug. 29, 2000, and entitled “Method and Apparatus for Processing Health Care Transactions through a Common Interface in a Distributed Computing Environment”, which is incorporated herein by reference in its entirety. For example, the host system may receive data related to insurance claim transactions from a variety of data formats, compression types, encryptions, native languages, countries of origin, or operating environments of origin, process the data to generate an interface definition language, and provide the processed data to a CCP workstation configured as a common interface structure for processing the insurance claim transactions. This allows the CCP to field inquiries regarding insurance claim transactions and retrieve the necessary information to address the issue or direct the claim transaction data to the appropriate processing area.

Furthermore, an application for automatic claim processing may be combined with additional customer service applications such as the one disclosed in U.S. Pat. No. 6,581,067, having an issue date of Jun. 17, 2003, and entitled “Method and System for Providing Administrative Support”, which is herein incorporated by reference in its entirety.

It should be understood that the method and system according to the present invention may be implemented using various combinations of software and hardware as would be apparent to those of skill in the art and as desired by the user. The present invention may be implemented in conjunction with a general purpose or dedicated computer system having a processor and memory components.

From the above description and drawings, it will be understood by those of ordinary skill in the art that the particular embodiments shown and described are for purposes of illustration only and are not intended to limit the scope of the present invention. Those of ordinary skill in the art will recognize that the present invention may be embodied in other specific forms without departing from its spirit or essential characteristics. References to details of particular embodiments are not intended to limit the scope of the invention.

What is claimed is:

1. A method for providing automated insurance claim processing comprising:
retrieving data associated with an insurance claim;
identifying at least one issue associated with the retrieved insurance claim data;
analyzing the insurance claim data and the at least one issue using at least one predefined condition to determine whether the at least one issue can be resolved automatically; and
automatically resolving the analyzed insurance claim data having the associated at least one issue meeting the at least one predefined condition when the insurance claim data can be resolved automatically.

2. The method of claim 1, wherein retrieving data comprises retrieving previously adjudicated health insurance claim data.

3. The method of claim 2, wherein analyzing comprises analyzing said previously adjudicated health insurance claim data to determine whether the previously adjudicated health insurance claim data includes missing data, incorrect data, or incomplete data.

4. The method of claim 2, wherein analyzing comprises analyzing said previously adjudicated claim data to determine that a payment associated with the retrieved previously adjudicated health insurance claim has been completed.

5. The method of claim 1, wherein analyzing comprises analyzing a reason code associated with the insurance claim data.

6. The method of claim 1, wherein analyzing further comprises determining whether the retrieved insurance claim data can be substituted with new claim data.

7. The method of claim 6, wherein determining that insurance claim data can be substituted comprises determining that insurance claim data is missing, incorrect, or incomplete.

8. The method of claim 1, further comprising generating a record identifying the retrieved insurance claim and the at least one issue associated with the retrieved insurance claim.

9. The method of claim 1, further comprising routing the analyzed insurance claim data having the associated at least one issue meeting the at least one predefined condition to an electronic work queue when the issue requires manual resolution.

10. The method of claim 9, further comprising communicating data required to resolve the at least one issue meeting the at least one predefined condition in the electronic work queue.

11. A system for enabling automatic insurance claim processing comprising:
data storage for storing claims data to be processed; and
a processor for:
retrieving data associated with an insurance claim;
identifying at least one issue associated with the retrieved insurance claim data;
analyzing the insurance claim data and the at least one issue using at least one predefined condition to determine whether the at least one issue can be resolved automatically; and
automatically resolving the analyzed insurance claim data having the associated at least one issue meeting the at least one predefined condition when the insurance claim data can be resolved automatically; and
routing the analyzed insurance claim data having the associated at least one issue meeting the at least one predefined condition to an electronic work queue when the insurance claim data requires manual adjustment.

12. The system according to claim 11, wherein the retrieved data is data associated with a previously adjudicated insurance claim.

13. The system according to claim 12, wherein analyzing comprises analyzing the previously adjudicated insurance claim data to determine whether there is previously adjudicated claim data that is missing, incorrect, or incomplete.

14. The system according to claim 11, further comprising a graphical user interface configured to display said retrieved claims data.

15. The system according to claim 14, wherein the graphical user interface is associated with the electronic work queue and is configured for manual claims adjustment for analyzed insurance claim data having the associated at least one issue meeting the at least one predefined condition that requires manual resolution.

16. The system according to claim 14, wherein the graphical user interface configured to display substitutable claim data fields.

17. A computer-implemented software application that enables a user to retrieve data associated with an insurance claim:
identify at least one issue associated with the retrieved insurance claim data;
analyze the insurance claim data and the at least one issue using at least one predefined condition to determine whether the at least one issue can be resolved automatically; and
route the analyzed insurance claim data for automatic resolution or for manual adjustment.
